(19) United States
(12) Patent Application Publication
(10) Pub. No.: US 2024/0043569 A1
(43) Pub. Date: Feb. 8, 2024

(54) METHOD FOR PRODUCING DERIVATIZED STARCH

(71) Applicant: Mondi AG, Wien (AT)

(72) Inventors: Tina OLKKONEN, Helsinki (FI); Elisabeth SCHWAIGER, St. Stefan (AT); Roman STEINDL, Zwettl (AT)

(73) Assignee: Mondi AG, Wien (AT)

(21) Appl. No.: 18/258,971

(22) PCT Filed: Dec. 23, 2021
(86) PCT No.: PCT/EP2021/087464

§ 371 Date: Jun. 22, 2023

(30) Foreign Application Priority Data
Dec. 23, 2020 (AT) A51141/2020

(51) Int. Cl. C08B 31/00

(52) U.S. Cl. CPC C08B 31/00

(57) ABSTRACT

A method for producing high-purity derivatized starch which to used in the manufacture of paper and cardboard, a starch raw material is subjected to at least the following steps: purification, slurrying, derivatization, gelatinization, pH adjustment, wherein a slurry of the derivatized starch obtained after the slurrying and derivatization method steps carried out in any sequence is subjected to purification, preferably at an alkaline pH and that the purified and gelatinized derivatized starch obtained after gelatinization is mixed at least once with dilute acid as well as application.

### BACKGROUND OF THE INVENTION

The present invention relates to a method for producing high-purity derivatized starch which can be used in the manufacture of paper and cardboard in which method a starch raw material is subjected to at least the following steps: purification, slurrying, derivatisation, gelatinization, Ph adjustment as well as application.

Starches and specifically both cationic starch and anionic starch are used in the paper and cardboard industry both as bulk starch and as surface starch as well as spray starch and coating starch, wherein depending on the time of usage, different properties of the paper or the cardboard are modified by the use of starch. The bulk starch thus serves as an adjuvant, for example, in dewatering, increases the strength of the paper or the cardboard and also helps to protect sizing agents, for example, or to eliminate impurities. Surface starches on the other hand influence the strength and stiffness of the paper or the cardboard and improve the printability of the paper or cardboard products produced. It is also known that native starches having no charge can be used as surface starches.

For the starch used in the paper or cardboard industry it is essential here that it is substantially free from impurities such as, for example, cellulose fibres, shell parts, fats or proteins since these substances can massively reduce the positive effects desired by using the starch on the paper or cardboard and in particular can lead to non-reproducible results of the quality of the manufactured paper or cardboard. In order to avoid these disadvantageous effects, the starch originating from maize, potatoes or wheat mainly used in the paper or cardboard industry is subjected to a purification before substitution of the glucose units on the starch molecule in order to separate the possibly perturbing impurities and/or concomitant substances as far as possible, wherein in particular the fats and also proteins contained in the starch can only be removed in a relatively small fraction from the native starch as a result of the Ph present during purification. After separation of the impurities and/or concomitant substances, the starch is either subject to a derivatisation, namely cationization or anionisation, the predominant fraction of the starches used being cationic starches in which glucose units are substituted for example by quaternary amines or the like, with the result that cationic derivatized starches with a predetermined degree of substitution are obtained. In industrial starch production for the paper and cardboard industry a plurality of starch products are usually offered which differ in their degree of substitution pre-selected by the manufacturer which is usually between about 0.4 and 0.1. In order to be able to use this derivatized starch in paper and cardboard manufacture, this must be made soluble in water in a further step for which it is boiled, whereupon the starch suspension or solution obtained is further diluted to the desired concentration for the definitive use. The step of boiling the starch can either be carried out at the starch manufacturer or at the end user.

EP 0 031 744 A2 discloses a method for producing cationic starch ether in which a purification is carried out after setting the Ph.

WO 2006/007045 A1 discloses a method for derivatisation of starch, in particular for producing cross-linked starch, which method however does not provide a purification step after the derivatisation.

EP 0 233 336 B1 discloses a method for dry cationization of starch in which starch is reacted with alkylidene epoxides in the presence of a powdery mixture of a calcium hydroxide or oxide and silicic acid.

U.S. Pat. No. 5,368,690 discloses a method for paper manufacture in which cross-linked cationized starch is gelatinized at excess pressure. In this method the starch was wet cationized by slurrying in water and adding sodium hydroxide as well as (3-chloro-2-hydroxypropyl)trimethyl ammonium chloride and epichlorohydrin and was dried after neutralisation and washing with water. The dried starch is then boiled by slurrying the starch in water to the desired viscosity.

A disadvantage with this procedure is on the one hand that an arbitrary degree of substitution of the starch is not available for purchase since, as is noted, only certain frequently requested starches are produced and that either large quantities of derivatized, gelatinized starch solution must be transported to the end customer or an energy-intensive drying step must be carried out in order that unnecessary amounts of liquid need not be transported. In such a case, the derivatized starch grains are usually filtered off, washed and dried and transported as derivatized but not gelatinized powder to the end customer. In any case, such starch products as before contain not inconsiderable fractions of impurities such as proteins, for example, which cannot or can only partially be removed in the purification step and thus are contained as perturbing concomitant substance in the derivatized starch used in paper or cardboard manufacture.

It has recently been considered to carry out the starch preparation directly on site in paper or cardboard manufacturing whereby an energy saving can be achieved and a degree of substitution of the derivatized starch desired by the respective manufacturer can be provided. To date however the problem of contamination of the product with proteins and reaction side products has not been able to be resolved and specifically independently of which of the two common derivatisation methods, dry or wet derivatisation, is used for the native starch.

### SUMMARY OF THE INVENTION

The aim of the present invention is therefore to provide a method by means of which perturbing impurities and/or concomitant substances can be successfully removed from a derivatized starch and furthermore the energy expenditure and use of raw materials or chemicals in such a method can be minimised.

In order to solve this object, the method according to the invention is substantially characterized in that a slurry of the derivatized starch obtained after the slurrying and derivatisation method steps carried out in any sequence is subjected to purification, preferably at an alkaline pH and that the purified and gelatinized derivatized starch obtained after gelatinization is mixed at least once with dilute acid. Since the process management is selected so that the purification of the starch is only carried out after the process steps of slurrying and derivatisation of the native starch or the raw starch executed in any sequence have been carried out, a significantly higher purity of the derivatized starch product can surprisingly be achieved than if the purification step is carried out directly on the raw starch or after the acid treatment. In particular, in such a purification step proteins contained in the starch raw material such as fibres, shell parts and the like can be almost completely separated. Furthermore, in such process management in addition to the impurities originating from the starch raw material or the native starch, chemicals used in the derivatisation, in particular the excesses thereof, are removed, whereby in particular the impurity content of the derivatized starch which is used in a subsequent gelatinization is reduced significantly compared with conventional methods. In addition, contaminating materials such as reaction side products, reagents, low-molecular starch degradation products but also salts such as sodium salts and material water can be removed from the starch suspension in the purification step.

In connection with the present invention, any vegetable starch or native vegetable starch which can be used without any pre-purification in the method according to the invention is understood as starch raw material. In addition to the starch required for the reaction, such a product contains not inconsiderable quantities of fibres, shell parts of plants, proteins and the like. In the present method not only potato starch and/or maize starch can be used as starch raw material but also, for example, tapioca starch, waxy maize starch, wheat starch, barley starch, rice starch, fruit starch and the like.

High-purity starch is understood as a starch whose non-starch-bound nitrogen content is reduced in relation to that of the starting material by at least 60%, preferably at least 75%, particularly preferably at least 90%. The nitrogen content is understood here as the amount of total nitrogen in the derivatized starch, i.e. both nitrogen which originates from the starch itself such as the protein nitrogen contained therein and also nitrogen which was introduced with the derivatisation reagents and/or activators or the like during the derivatisation or which possibly originates from reaction products of the derivatisation.

Derivatized starch is understood in connection with the present invention as a starch in which glucose units on the starch were substituted by either cationic, anionic but also both cationic and anionic groups. Derivatized starches obtained in such a derivatisation are subsequently designated as cationic, anionic or also bionic or amphoteric starches depending on the selected derivatisation and the ionic charge of the groups introduced during the derivatisation.

According to a further development of the invention, the purification step is substantially carried out so that the slurrying of derivatized starch by washing and concentrating is carried out in a device selected from a decanter, hydrocyclone or separators, preferably at an alkaline pH. By carrying out the purification step by washing and subsequent concentrating in a device selected from a decanter, hydrocyclone or separators, in the alkaline range, whereby water-soluble salts such as sodium salts, water-soluble reaction by-products such as glycols but also low-molecular water-soluble starch decomposition products, residual reagents and all other water-soluble substances can be removed from the starch in one and the same device in a first step by adding a washing substance, in particular water, whereby the loading of optionally interfering substances on the subsequent gelatinization is significantly reduced. In a further step such as, for example, a decanting step or a further purification of the pre-purified material in a hydrocyclone, residual impurities such as shell parts, fibres and the like can be removed from the starch raw material so that due to the process management in which derivatisation is carried out first and then purification, the degree of purification of the derivatized starch can be reduced substantially compared with conventional methods. By selecting special purification devices such as a decanter, hydrocyclone or separators, this purification effect can be improved even further. Since the purification of the slurry of derivatized starch is carried out in at least two steps, namely a first alkaline washing step and a second step of washing and concentrating the slurry, further impurities can be separated from the slurry of derivatized starch, in particular substances such as fibres and proteins which can be washed out particularly effectively alkalinically. Furthermore, with such process management, the pH of the starch suspension can be successfully held in an optimal basic range, with the result that not only a premature gelatinization in a washing step can be avoided but particularly in the subsequent gelatinization step, a more efficient gelatinization can be achieved, since as the person skilled in the art is aware, alkaline starch can be boiled significantly better than neutral starch or even slightly acidic starch. In any case, with such process management a better swelling of the starch can be achieved with the result that a significantly higher-quality and in particular a particularly high-purity product can be obtained.

In order not to leave the pH too strong in the basic range, according to a further development of the invention the second step of washing in the purification step is carried out with the addition of at least one acid selected from mineral acids such as hydrochloric acid, sulphuric acid or phosphoric acid or organic acids such as fumaric acid or citric acid whilst at the same time setting the pH to values between 7 and 9. With such process management it is possible to set the optimal pH during washing of the derivatized starch for the subsequent gelatinization in order to be able to subsequently achieve a gelatinization that is as complete as possible and in particular rapid. In the purification step cited above all the acids familiar to a person skilled in the art in the field of starch derivatisation can be used either alone or in combination. The only essential thing is that the purification is carried out after the derivatisation and before the boiling or the gelatinization, preferably at an alkaline pH.

Since, as corresponds to a further development, in the purification step the slurry of derivatized starch is concentrated in the purification to a solid content of 2 to 42 wt. %, in particular 5 to 35 wt. %, it is possible to obtain a concentrated starch slurry for the subsequent gelatinization or the subsequent boiling with which the gelatinization can be carried out directly without further addition of moisture. Since in the process management according to the invention, any drying step is omitted, a substantially saving of energy is achieved whilst at the same time obtaining a highly purified product that can be used directly in paper manufacture, for example as bulk starch or as surface starch such as sizing agent, for example. By carrying out the process so that any drying step is omitted, it can furthermore be prevented that impurities such as proteins which are insoluble in water during drying as a result of the denaturing which takes place in this case, and which attach to the starch grains or fix thereto, remain in the subsequent boiling and consequently in the starch prepared for use. For the actual use of the product, the starch solution must subsequently be diluted to the desired concentration and set to the desired pH. Since a drying step can be omitted, it is furthermore ensured that no possible surface cornification of the starch grains of the derivatized starch can occur which can result in a loss of efficiency of the derivatized starch when used in the manufacture of paper or cardboard.

For setting the desired pH after gelatinization, according to a further development, the method according to the invention can substantially be conducted so that the purified and gelatinized derivatized starch obtained after the gelatinization is subjected to a two-stage acidification. With such process management, the pH of the gelatinized starch can be set in a first acidification step to values of 6.0 to about 8.5, for example, a pH at which gelatinized starch can be stored over a fairly long time without deterioration. It may be necessary to store gelatinized starch for various reasons which can comprise, for example, a pre-production of larger quantities of gelatinized starch or necessary repairs or maintenance work on the paper machine during a continuous production of gelatinized starch. In a second acidification step the pre-acidified or substantially neutral derivatized and gelatinized starch can then be adapted to the optimal pH for the particular usage on the paper machine. For example, for sizing applications such as for example alkenyl succinic acid anhydride applications, lower pH values are more favourable than, for example, for a use as bulk starch. When the gelatinized starch is used as bulk starch in thick matter, the process can be carried out so that the starch is set to a lower pH, with the result that the lowering of the cellulose fibre mixture used in this process step can be avoided by adding aluminium sulphate or sulphuric acid, since the setting of the pH can only be accomplished by the bulk starch. With such process management it is thus not only possible to make a substantial saving of chemicals such as aluminium sulphate but a pH setting step of the cellulose fibre mixture can additionally be omitted. The person skilled in the art knows that thick matter can comprise a consistency range of 3 to 35 wt. %, in particular 4 to 30 wt. %. With such process management, two substantial advantages for processes to be used on a large scale can be achieved, the gelatinized, purified starch can both be stored for a long time without deterioration and due to the two-stage pH setting, a substantial saving on chemicals can be achieved.

As a result of the dominant importance of cationized starch in the paper and cardboard industry, according to a further development of the invention the method is conducted so that a cationization is carried out as derivatisation with a base selected from the group of alkali hydroxides such as NaOH, KOH, LiOH, alkali carbonates such as Na₂CO₃ or alkaline earth oxides such as CaO or alkaline earth hydroxides such as Ca(OH)₂, in particular NaOH, a cationization reagent, in particular 3-chloro-2-hydroxy-propyl-trimethyl ammonium chloride or an epoxidic cationization reagent such as 2,3 epoxy-propyl-trimethyl-ammonium chloride as well as optionally further substitution reagents and optional adjuvants selected from activators such as silicates, calcium oxide or calcium hydroxide. The cationic derivatisation can be carried out either as dry cationization or as wet cationization, wherein in the former case a derivatisation of the dry starch is firstly carried out under alkaline conditions and then a slurrying is carried out in acidified water and in the second case of a wet derivatisation the raw material, the starch is slurried in water mixed with swelling protection salts such as sodium sulphate, sodium chloride, calcium chloride and alkali hydroxides or alkaline earth hydroxides and then cationized with a cationization reagent such as 3-chloro-2-hydroxy-propyl-trimethyl ammonium chloride or 2,3 epoxy-propyl-trimethyl-ammonium chloride at pH values of 11 to 12. The process management in relation to pH values, temperatures, concentrations and reaction times is known from the prior art in both cases but it has surprisingly been shown that both a dry-cationized starch and also a wet-cationized starch can be purified during a subsequent purification to a significantly higher purity than a starch derivatized by a conventional method if the starch purification step is carried out after cationization in the alkaline range and not beforehand.

According to a further development of the invention, the process is carried out so that sodium hydroxide solution, in particular sodium hydroxide solution recycled from pulp production, is used in the cationization. Since sodium hydroxide solution, in particular recycled sodium hydroxide solution originating from pulp production is used as cationization agent in the cationization in this case, on the one hand the chemicals requirement is reduced and on the other hand, it is ensured that the sodium hydroxide solution always present in paper and pulp production can be appropriately reused. It has surprisingly been found that in relation to the purification of the cationized starch thus produced, the subsequent purification is able to separate again all the impurities that had possibly been introduced with the recycling base from this product.

It has proved to be particularly favourable in connection with the present method that the cationization is carried out to a degree of cationization between 0.02 and 0.5, in particular a degree of cationization between 0.04 and 0.35, required in the subsequent paper and cardboard production. Here the requirements of the respective paper and pulp production can be met exactly and it is not necessary to select a compromise between available degrees of substitution and necessary degrees of substitution of the starch as is the case with commercially available starches but the substitution can be carried out precisely up to the point which is necessary and particularly favourable in the respective paper and cardboard production. This advantage would theoretically be achievable with the method according to the prior art but in practice, particularly when starch must be supplied or must be purchased from a third party, cannot be achieved since only specific products are produced identically and industry production cannot be individualized. For this reason, preferably an on-site use of the method in a lignin, pulp, paper or cardboard factory since the exactly required degrees of cationization or anionisation or derivatisation can then be provided.

Finally it has been found that various starch raw materials can surprisingly be used with the process management according to the invention without resulting in a deterioration in the process yield. For this reason, the method according to the invention is further developed such that a native starch selected from bulbous starch such as potato starch or tapioca starch, cereal starch such as maize starch, waxy maize starch, wheat starch, barley starch, rice starch or fruit starch such as starch from legumes or mixtures of two or more thereof is used as starch raw material. In addition to the starches usually used in paper and pulp production such as potato starch, maize starch or also possibly wheat starch, all other starch-containing plants can be used as starting materials delivering the starch raw materials can be used since, as a result of the possibility of carrying out an efficient purification after the derivatisation, higher degrees or impurities which can originate from cereal starches, for example, can be arbitrarily separated at any time.

### DESCRIPTION OF THE DRAWING

The invention is explained in detail hereinafter with reference to a drawing and exemplary embodiment and in particular a comparison of the process management according to the prior art and the process management according to the invention is shown from which it can be seen that the derivatized starch which can be obtained by the method according to the invention has a significantly higher purity than that which can be obtained by the methods according to the prior art.

FIG. 1 shows a flow diagram which depicts the possible process sequences for producing derivatized starch according to the invention.

### DETAILED DESCRIPTION OF THE INVENTION

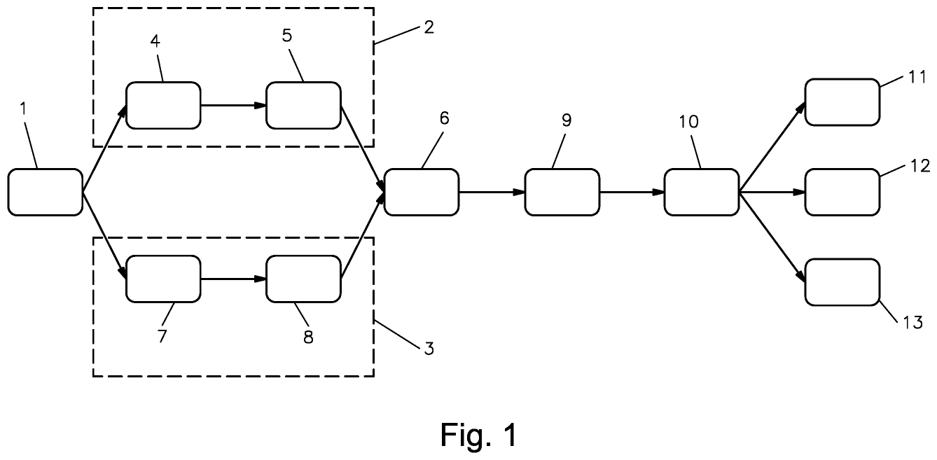

In FIG. 1 is a starch storage silo in which an arbitrary starch not purified previously, selected from a bulbous starch such as potato starch or tapioca starch, a cereal starch such as maize starch, wheat starch, barley starch or the like or a fruit starch such as a starch from legumes or mixtures thereof is stored. From this starch storage silo 1 the starch is either conveyed to a wet derivatisation generally designated by cycle 2 or to a dry derivatisation generally designated by cycle 3. In this case, in the wet derivatisation 2 starch from the starch storage silo 1 is conveyed by means of a conveyor screw into a slurry container 4 in which it is mixed with water to a starch suspension, with a starch concentration of 30 to 40 wt. % by agitating. A protective salt, for example, Na₂SO₄ is added to this starch suspension and agitated further. The wet derivatisation is then carried out either in the slurry container 4 itself or in a separate derivatisation container 5 by adding a cationization agent such as 2,3 epoxy-propyl-trimethyl-ammonium chloride, optionally activators or further substitution reagents such as salts for a phosphorisation. This mixture is further agitated for a period of about 20 minutes and then the pH is gradually increased to a pH of 11.8 by adding 4% NaOH and agitated further. In order to complete the cationization, the temperature is increased to about 40° C. and the reaction mixture is held at a pH of 11.8 over the total reaction time by adding sodium hydroxide solution as required. After the end of the reaction the pH of the reaction mixture is reduced to a pH of 9 by adding diluted mineral acid such as hydrochloric acid in a purification step 6 and held for a short time.

In order to separate the excess cationization agent, the reaction by-products, the salts that have been added and formed as well as the dissolved proteins and raw material impurities, the suspension of the cationized starch is purified by adding further water using a decanter, hydrocyclone or separators. The purification step can possibly be carried out twice or several times to remove remaining impurities.

If this is necessary, the cationized starch thus produced can be stored at a temperature between 4 and 25° C., a pH of 7.1 to 9 which is optionally set by adding dilute acid. In this case, the starch has a density between 12° Beaumé and 21° Beaumé or 15 wt. % to 39 wt. % of starch in the slurry. Naturally the starch can be further processed immediately without storage.

An alternative model is dry derivatisation which is carried out according to cycle 3. For this purpose non-pre-purified starch from the starch storage silo 1 is introduced into the mixing area 7 by means of a conveyer screw where it is mixed and blended with solid calcium hydroxide, an activator such as silicates and the like. In order to carry out the derivatisation, a small quantity of water and sodium hydroxide solution is sprayed onto the dry starch mixture and mixed, the cationization agent such as 2,3-epoxy propyl trimethyl ammonium chloride is then sprayed on and mixed and then the temperature is gradually increased to a reaction temperature of 30 to 80° C. and left to stand at the reaction temperature for 24 hours to 120 hours for completion of the reaction in order to reach the desired degree of substitution of the starch. The cationized starch is then slurried with dilute mineral acid in slurring area 8 until the pH has dropped to about 7 to 10. The thus cationized starch is then fed to purification area 6 for removal of excess cationization agent, reaction by-products, salts which have been added and formed, raw material impurities, dissolved proteins and the like whereby water was added and the starch is purified using the decanter, hydrocyclone or separators. After the purification step the starch can optionally be stored or fed directly to gelatinization. Such a cationized starch is stored at temperatures between 4° C. and 25° C., a pH of 7.1 to 9 which has been set by adding dilute mineral acid, a density between 12° and 21° Beaumé or 15 wt. % to 39 wt. % of starch in the slurry.

The cationized starch is then fed directly from the purification stage or from a storage tank to a gelatinization area 9, whereby it is boiled in a steam injection boiler at about 125° C. for 1 to 20 minutes with a concentration of the starch suspension in the boiler between 4 wt. % and 38 wt. %.

The starch thus gelatinized can then be stored either in a stacking tank 10 at about 70° C. and a pH of 7 to 8.5 which is achieved by adding dilute mineral acid and then further diluted for the respective use in the paper and pulp industry or the pH can be set. In the stacking tank the gelatinized starch has a temperature of about 70° C., a concentration of 3 to 35 wt. % and a pH between 7 and 8.5.

In the stacking tank 10 the starch can then be re-used in an alkenyl succinic acid anhydride (ASA) method 11 in which the gelatinized starch (1 to 4 wt. %) is set to a pH of 2 to 6.5 by adding dilute acid, in particular mineral acid. A further possible use in the application of the gelatinized starch as the bulk starch in thick matter as indicated at 12. Here the content of gelatinized starch in the suspension is 1 to 4 wt. %, the pH is again between 2 to 6.5 which is adjusted by adding dilute mineral acid, which pH can optionally be adjusted depending on the desired pH of the of the paper pulp thick matter. The third possible use is the application of the gelatinized starch as bulk starch in thin matter as is indicated at 13, wherein the concentration of the starch suspension is substantially the same as that of the ASA or the thick matter application although the pH is selected to be somewhat higher, namely 5 to 7 which pH is also set by using dilute mineral acid.

The method according to the invention differs compared with the conventional method for producing derivatized, gelatinized starch in respect of the purification step which is provided after the derivatisation, which purification step was hitherto unknown in the case of a dry-cationized starch since dry-cationized starch according to the prior art is used without any further purification and which differs from wet-cationized starch in that not only a simple rinsing with water is provided but a specially selected purification device such as a hydrocyclone, decanter or also separators is used by means of which it is surprisingly possible not only to separate water-soluble contaminants but also as a result of the basic conditions of the purification step to separate all alkalinically soluble proteins, starch impurities, reaction by-products such as glycols, residue reagents such as residual epoxides and also low-molecular starch decomposition products. With this process management it is therefore possible to obtain, starting from a non-pre-purified starch raw material, a high-purity derivatized starch by means of which a better swelling is then achieved in the gelatinization with the result that a higher-quality high-purity product can be achieved overall.

The method described above for producing high-purity derivatized starch is then compared by using various non-pre-purified initial starches with the conventional cationization methods, and specifically both wet and dry cationization methods. For the comparative tests the wet and dry cationization as described in the literature was carried out. In dry cationization, after the cationization process the reaction mixture is pre-dried in a warm air drier at 50° C. and fumaric acid is added until a 5% suspension of the powder obtained in water at a pH of 5.5 was obtained. In wet cationization according to the prior art, cationization was also carried out as known from the literature and after the end of the reaction the reaction mixture obtained was acidified with dilute hydrochloric acid to a pH of 5.5, filtered and washed twice with water and the filter cake was dried to a dry powder in a warm air drier at 50° C.

The dry cationization method or wet cationization method according to the invention was carried out as shown in the flow diagram, in the wet cationization the purification was carried out at the end of the reaction by adding dilute mineral acid until a pH of 9 was achieved and the suspension was concentrated in a hydrocyclone. The concentrated starch suspension thus obtained was adjusted to pH 7 by adding dilute mineral acid and dried in a warm air drier at 50° C. to obtain a sample for the subsequent analysis. In the case of dry cationization, after the end of the reaction water was added with pH 8 until a suspension having a content of 30 wt. % starch was obtained, the suspension was adjusted to pH 8 by adding further dilute mineral acid, the slurry was purified in a hydrocyclone and the concentrate thus obtained was adjusted to pH 7 with dilute mineral acid, filtered and the filter cake obtained was dried to a dry powder in a warm air drier at 50° C. to obtain a sample for the following analysis.

The experiments were carried out using potato starch and maize starch and when examining the efficiency of the method according to the invention, on the one hand the total nitrogen after purification was determined by the Kjeldahl method, wherein % N according to the standardized Kjeldahl method gives the total nitrogen present in the sample which corresponds to the % nitrogen which was actually substituted +% nitrogen from the reaction by-products +% nitrogen from the proteins obtained.

A second examination criterion related to the insoluble components in the dry substance. In this case, 100 g of sample after acid hydrolysis was left to react in 600 ml of 0.1 normal hydrochloric acid at 100° C. for 30 minutes and the insoluble residue was determined gravimetrically after filtration and washing twice with distilled water. The results are shown in the following Table 1.

TABLE 1

| Experiment | | | | % N of dry substance according | |
|---|---|---|---|---|---|
| Number | Starch type | Prior art | Invention | to Kjeldahl | Insoluble dry substance |
| 1 | Potato starch 1 | Dry method | | 0.40 | 630 mg/kg |
| 2 | Potato starch 1 | | Dry method | 0.26 | 100 mg/kg |
| 3 | Maize starch 1 | Dry method | | 0.37 | 570 mg/kg |
| 4 | Maize starch 1 | | Dry method | 0.29 | 120 mg/kg |
| 5 | Maize starch 2 | Wet method | | 0.36 | 2400 mg/kg |
| 6 | Maize starch 2 | | Wet method | 0.29 | 450 mg/kg |
| 7 | Maize starch 2 | Wet method | | 0.22 | 630 mg/kg |
| 8 | Maize starch 2 | | Wet method | 0.16 | 290 mg/kg |
| 9 | Maize starch 3 | Dry method | | 0.42 | 330 mg/kg |
| 10 | Maize starch 3 | | Dry method | 0.29 | 130 mg/kg |
| 11 | Potato starch 2 | Wet method | | 0.41 | 910 mg/kg |
| 12 | Potato starch 2 | | Wet method | 0.31 | 100 mg/kg |

It can be seen from Table 1 that in all the experiments which were carried out according to the method of the present invention, the total Kjeldahl nitrogen after purification according to the invention is lower than that in a purification according to the prior art, likewise the content of insoluble substances in the dry substance could be reduced significantly compared with the method according to the prior art, in some cases even by about 90%.

The purified derivatized starch thus produced was then used in thick matter, in thin matter and sizing agent in the following concentrations or under the following conditions and possible improvements or savings of chemical were investigated.

### EXAMPLES

### Application in Thick Matter

The high-purity derivatized starch, in particular maize starch, potato starch or mixtures thereof which can be used cationically, anionically or amphoterically, was used in the mass in the thick matter in the consistency range from 3 to 35 wt. % (corresponds to 30 to 350 g of pulp atro/I water), in particular 4-30 wt. % in a quantity of 0.05-2.5% relative to the dry pulp or the paper to increase the paper strengths, in particular the paper dry strengths but also for fixing impurities. The application which is carried out at pH values of 5 to 9, optionally by adding other process adjuvants and temperatures of 30 to 80° C. is usually carried out by using already ground fibrous material which is mixed with high-purity derivatized starch. Optionally non-ground fibrous material can also be used. Furthermore, the fibrous material can have previously been subjected to a high-consistency and/or a medium-consistency and/or a low-consistency grinding (fibrous material contents: high-consistency grinding: 20-35%, medium-consistency grinding: 10-20%, low-consistency grinding: 3-10%).

Since high-purity derivatized starch was used in the thick matter, it is possible to reduce the amount of aluminium sulphate by about 30% since on the one hand, starch acidified to the special desired intended usage could be used (as a result of the on-site manufacture of the high-purity derivatized starch) and on the other hand, it was only necessary to add significantly reduced amounts of defoamer in the thick matter, which can be attributed to the fact that the non-starch-bound nitrogen content in the derivatized starch could be significantly reduced, with the result that the foaming could be reduced without adding defoamer.

### Application in Thin Matter

The high-purity derivatized starch, in particular maize starch, potato starch or mixtures thereof which can be used cationically, anionically or amphoterically, is used in the mass in the thin matter in the consistency range from 0.15 to 3%, in particular 0.18-2% in a quantity of 0.05-0.5% relative to the dry pulp or the paper to increase the fine material retention and for fixing impurities. The application is carried out at pH values of 5 to 8, temperatures of 30 to 80° C. and optionally whilst adding further process adjuvants.

Since the high-purity derivatized starch was used in the thin matter, it is possible to improve the reaction behaviour and in particular the white water can be adjusted to the optimal desired pH with the result that on the one hand, the fine material fibre load can be controlled and on the other hand, savings of retention agents can be brought about. Furthermore, it was only necessary to add reduced quantities of a defoamer in the thin matter which can be attributed to the fact that the non-starch-bound nitrogen content in the derivatized starch could be reduced significantly with the result that the foaming could be reduced without adding defoamers.

### Application in ASA Sizing Method

The high-purity derivatized starches, in particular maize starch, potato starch or mixtures thereof which can be used cationically, anionically or amphoterically are preferably used in an acid-washed state with a pH of 2 to <7 in the manufacture of emulsions with sizing agent such as ASA (alkenyl succinic acid anhydride). In this case, the starches are used as protective colloid in a quantity of 0.05-0.3% relative to the dry pulp or paper to produce a stable sizing agent emulsion. The temperatures used are max. 60° C. and the pH values are preferably a maximum of 8, preferably a maximum of 7, particularly preferably in the range between pH 2 and pH since otherwise decomposition products from the sizing agent must be expected which is overall inefficient and furthermore, the formation of deposits and deposition of these decomposition products on various plant parts in the paper machine is unfavourable for operation of the paper machine since in this case, it is necessary to clean the machine using cleaning chemicals.

Since a high-purity derivatized starch was used, it is possible to adjust the pH to the lowest possible and therefore ideal pH which prevents the starch from hydrolysing and therefore a better sizing effect can be achieved. Experiments have shown that when using high-purity derivatized starch, Cobb values according to ISO 535:2014 could be achieved which corresponded to those of conventional sizing methods but for which less than 10% more ASA must be used to achieve the corresponding Cobb values.

In each of these types of use, it has been shown that when using the high-purity derivatized starch produced according to the invention, substantially a saving of chemicals such as aluminium sulphate could be achieved and in addition in this process management a pH adjustment of the pulp fibre mixture treated with the starch could be omitted.

1. Method for producing high-purity derivatized starch to be used in the manufacture of paper and cardboard, a starch raw material is subjected to at least the following steps: purification, slurrying, derivatization, gelatinization, pH adjustment, wherein a slurry of derivatized starch obtained after slurrying and derivatization method steps carried out in any sequence is subjected to purification, at an alkaline pH and the purified and gelatinized derivatized starch obtained after gelantinization is mixed at least once with dilute acid.

2. The method according to claim 1, wherein the purification of the slurry of derivatized starch is obtained by washing and concentrating in a container selected from a decanter, hydrocyclone or separators at an alkaline pH.

3. The method according to claim 2, wherein the slurry of derivatized starch is purified in at least two steps, a first alkaline washing step and a second step of washing and concentrating the slurry.

4. The method according to claim 2, wherein the second step of washing is carried out by adding at least one acid selected from mineral acids and/or organic acids at a pH between 7 to 9.

5. The method according to claim 1, wherein in the purification the slurry of derivatized starch is concentrated to a solid content of 2 to 42 wt. %.

6. The method according to claim 1, wherein the purified and gelatinized derivatized starch obtained after the gelatinization is subjected to a two-stage acidification.

7. The method according to claim 1, wherein as derivatization, a cationization is carried out with a base selected from the group of alkali hydroxides NaOH, KOH, LiOH, alkali carbonate Na₂CO₃ or alkaline earth oxide CaO, or alkaline earth hydroxide Ca(OH)₂ or NaOH, a cationization reagent 3-chloro-2-hydroxy-propyl-trimethylammonium chloride or an epoxidic cationization reagent 2,3 epoxy-propyl-trimethylammonium chloride and further substitution reagents and optional adjuvants selected from activators selected from silicates, calcium oxide or calcium hydroxide.

8. The method according to claim 7, wherein sodium hydroxide solution, recycled from a pulp production, is used in the cationization.

9. The method according to claim 1, wherein the cationization is performed to a degree of cationization between 0.02 and 0.5 required in the subsequent paper or cardboard production.

10. The method according to claim 1, wherein a native starch selected from potato starch or tapioca starch, cereal starch selected from maize starch, waxy maize starch, wheat starch, barley starch, rice starch or fruit starch selected from starch from legumes or mixtures of two or more thereof is used as starch raw material.

11. The method according to claim 1, wherein the starch is used immediately after its derivatization in lignin, pulp, paper or cardboard manufacture.
